(19) United States
(12) Patent Application Publication
(10) Pub. No.: US 2013/0088728 A1
(43) Pub. Date: Apr. 11, 2013

(54) SPOT COLOR EDITING ASSISTANT TOOL FOR SPOT COLOR REPRODUCTION

(71) Applicants: Yongda CHEN, San Diego, CA (US); Jonathan Ireland, Lancaster, PA (US); J. Michael Sanchez, Rochester, NY (US)

(72) Inventors: Yongda CHEN, San Diego, CA (US); Jonathan Ireland, Lancaster, PA (US); J. Michael Sanchez, Rochester, NY (US)

(73) Assignee: XEROX CORPORATION, Norwalk, CT (US)

(21) Appl. No.: 13/253,638

(22) Filed: Oct. 5, 2011

(51) Int. Cl. H04N 1/60

(52) U.S. Cl. 358/1.9

(57) ABSTRACT

A computer-implemented method for imaging of spot colors within a document using a spot color editor is provided. The method includes determining a spot color formula, using a spot color editor, for providing a colorimetric match to a desired spot color in a print job, wherein the spot color is within a color space and the spot color formula includes colorant values for each color in the color space; printing a test image of the spot color with the determined spot color formula for analysis, wherein the color composition of the spot color test image is analyzed by a user to determine whether desired image quality is achieved; and determining an updated spot color formula for providing a colorimetric match to the desired spot color in the print job based on a received input, if the desired image quality is not achieved.

### BACKGROUND

1. Field

The present disclosure relates to methods and systems for color management in image/text printing or display systems, and more particularly to a method and a system for imaging of spot colors within a document using a spot color editing assistant tool.

2. Description of Related Art

Spot color (Pantone™ or other) reproduction is important for the printing industry, as a preferred method of maintaining accuracy to corporate identity colors across printing systems.

To meet customer demand, the commercial printing industry requires the capability of producing spot colors accurately and consistently. Spot colors can be defined as a fixed set of colors which may be Pantone™ colors, customer logo colors, colors in a customer's proprietary marked patterns, or customer defined colors in the form of an index color table. Spot colors are often used, or can be used, for large background areas, which may be the most color critical portion of a particular page. Consistent color in these areas may determine the difference between success or failure in meeting customer requirements.

Customers require not only high spot color reproduction accuracy, but also good image quality. For the accuracy requirement, the reproduced spot colors are matched to the color patches on the swatch books issued by Pantone™ and other companies. The spot color aims (CIELab values) are provided by Pantone™ and other companies and are integrated into a Digital Front End (DFE) system. The spot color reproduction accuracy is evaluated by comparing the color difference between the reproduction color and spot color targets (or aims). Goal is to decrease spot color reproduction errors to an image output terminal (IOT) white noise level. At the same time, image quality is also very important for spot color reproduction.

The image quality criteria include line/edge quality, graininess, color constancy, smoothness, ink combinations (e.g., Zero K for drop out ink scanning) etc. The particular mix of colorant combinations in the CMYK recipes can affect these image qualities. For CMYK or other multiple colorant printing, it is known that one color can be achieved by multiple colorant combinations by using different black generation strategies. Although different colorant combinations provide similar spot color reproduction accuracy, their image quality may vary.

Unlike reproduction accuracy, there is no generally accepted objective standard for print quality. The print quality is closely related to the customers' preferences and it may vary depending on different colors, applications and/or environments.

Currently, a pre-selected black generation strategy is used to build the default spot color lookup table from reference CIElab values and Engine destination profiles. When customers do not prefer the resulting recipe(s) due to image quality issues, they may manually edit the recipe using a Spot Color Editor tool.

The spot color editor allows the customer to manually adjust one or more colorants in a color model to obtain alternate spot color recipes. The spot color editor also provides various methods to satisfy the accuracy requirements of the default recipes. These methods include International Color Consortium (ICC) profile (i.e., a set of data that characterizes a color input or output device, or a color space) updater, iteration on printer model, and iteration on printer, working together to choose one default accurate recipe for each color.

It is, however, very difficult for customers to manually compose an accurate spot color recipe in the highly nonlinear colorant space without proper tools. For example, it is difficult for anyone to know which direction to go for an accurate match and it is also difficult and subjective to know when they have arrived with the accurate match. So customers generally lose the spot color reproduction accuracy after they compose their own spot color recipes. In addition, it may take customers a lot of time and effort to figure out an accurate spot color recipe that they prefer for image quality by using the existing iterative manual change-print-and-visually evaluate cycle. Accuracy is totally dependant on the customer's or operator's visual perception skill, lighting conditions, etc.

For example, a particular dark blue color may be built with high levels of C, M, and K, but with none at 100%, so they all are screened, giving rough jaggy edges to small type. This same color may be achieved with more C and less K, giving a smooth edge. To identify this alternate recipe using the existing spot color editor involves multiple manual iterations of the Spot Color Editor tool to change, print, and visually evaluates the proposed recipe.

The present disclosure provides improvements over the prior art.

### SUMMARY

According to one aspect of the present disclosure, a computer-implemented method for imaging of spot colors within a document using a spot color editor is provided. The method is implemented in a computer system comprising one or more processors configured to execute one or more computer program modules. The method includes determining a spot color formula, using a spot color editor, for providing a colorimetric match to a desired spot color in a print job, wherein the spot color is within a color space and the spot color formula comprises colorant values for each color in the color space; printing a test image of the spot color with the determined spot color formula for analysis, wherein the color composition of the spot color test image is analyzed by a user to determine whether desired image quality is achieved; and determining an updated spot color formula for providing a colorimetric match to the desired spot color in the print job based on a received input, if the desired image quality is not achieved.

According to another aspect of the present disclosure, a system for imaging of spot colors within a document using a spot color editor is provided. The system includes a processor and a print engine. The processor is configured to determine a spot color formula for providing a colorimetric match to a desired spot color in a print job. The spot color is within a color space and the spot color formula includes colorant values for each color in the color space. The print engine is configured to print a test image of the spot color with the determined spot color formula for analysis. The color composition of the spot color test image is analyzed by a user to determine whether desired image quality is achieved. The processor is also configured to determine an updated spot color formula for providing a colorimetric match to the desired spot color in the print job based on a received input, if the desired image quality is not achieved.

Other objects, features, and advantages of one or more embodiments of the present disclosure will seem apparent from the following detailed description, and accompanying drawings, and the appended claims.

### BRIEF DESCRIPTION OF THE DRAWINGS

Various embodiments will now be disclosed, by way of example only, with reference to the accompanying schematic drawings in which corresponding reference symbols indicate corresponding parts, in which

FIGS. 1A and 1B illustrate a method for imaging of spot colors within a document using a spot color editing assistant tool in accordance with an embodiment of the present disclosure;

FIG. 2 illustrates a system for imaging of spot colors within the document using the spot color editing assistant tool in accordance with an embodiment of the present disclosure; and

FIG. 3 is a graphical user interface (GUI) depicting the spot color editing assistant tool in accordance with an embodiment of the present disclosure.

### DETAILED DESCRIPTION

Existing automated spot color editor uses printer models and known spot color targets to select a specific CMYK recipe that provides a close colorimetric match to the desired spot color. In CMYK (or other multiple colorant printing systems such as CMYKOV, CMYKOG, etc.) printing system, however, there may be different combinations of colorants that produce the same visual color. The spot color editor currently selects one of these combinations, but different options may have different image quality impacts. For example, some CMYK recipes may be better for fine line or text quality. If the system-selected CMYK recipe yields undesirable image quality artifacts, the existing automated spot color editor allows a user or an operator to manually search for an alternate CMYK recipe by making visual (or offline) assessments of color match accuracy. However, it is very difficult for the user to obtain same color appearance by tuning spot color recipes in the highly nonlinear colorant space without proper tools.

The present disclosure provides a spot color editing assistant tool that helps the user identify an accurate, alternate spot color recipe(s) that also satisfy his/her image quality preferences. The spot color editing assistant tool bridges the gap between simultaneous color reproduction accuracy and print image quality for spot colors. The spot color editing assistant tool disclosed herein can easily be incorporated in the existing automated spot color editor tool.

The spot color editing assistant tool derives a full spot color recipe based on one colorant amount input by the user. The present disclosure allows the user to force one of the colorants (e.g., Cyan (C), Magenta (M), Yellow (Y), or Black (K)) in a color space (e.g., CMYK) to a fixed level, and the system then uses this fixed level colorant as a constraint when searching for the alternate spot color recipe for providing an accurate match to the desired spot color. Once the alternate (constrained) spot color recipe is found, the user evaluates the alternate spot color recipe to assess whether objectionable image quality artifacts are addressed without losing accuracy in color rendition.

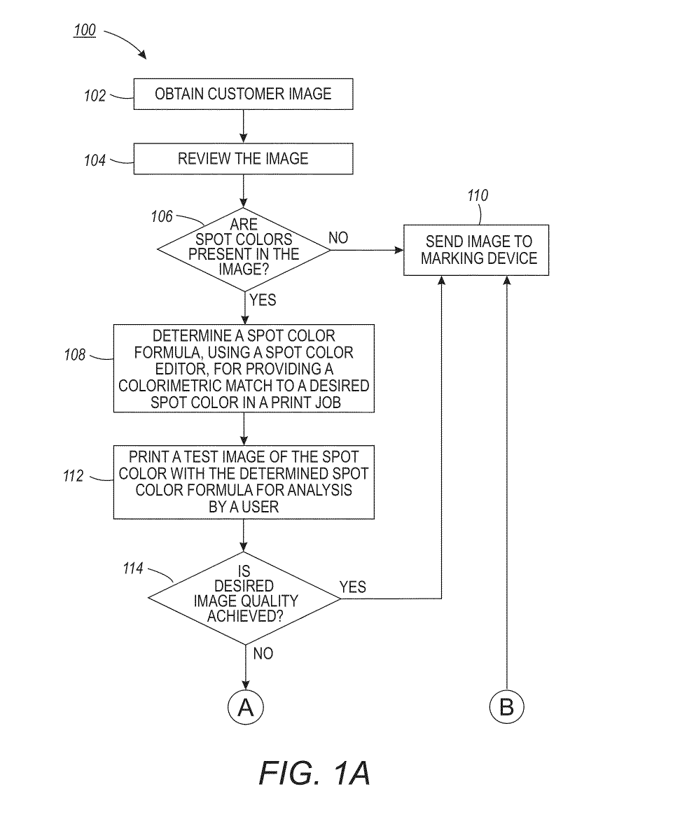

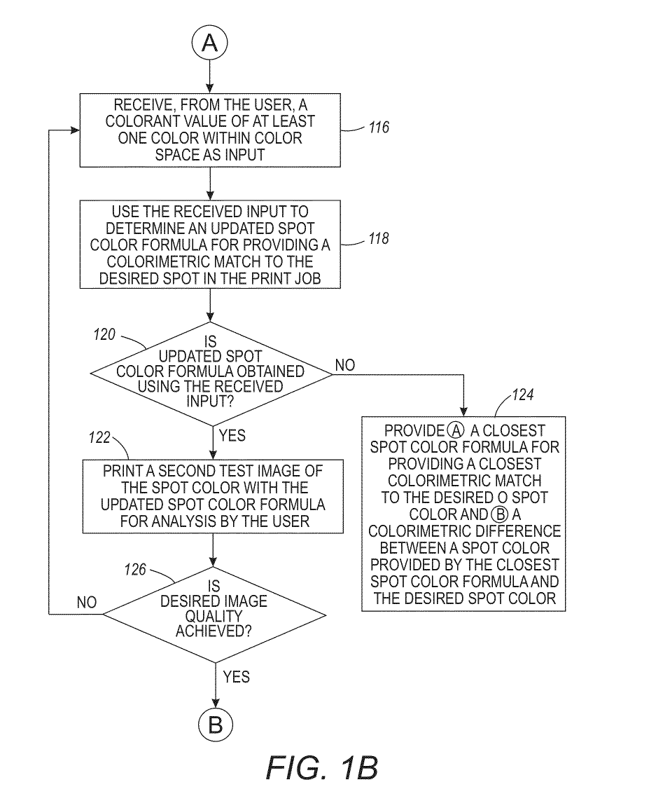

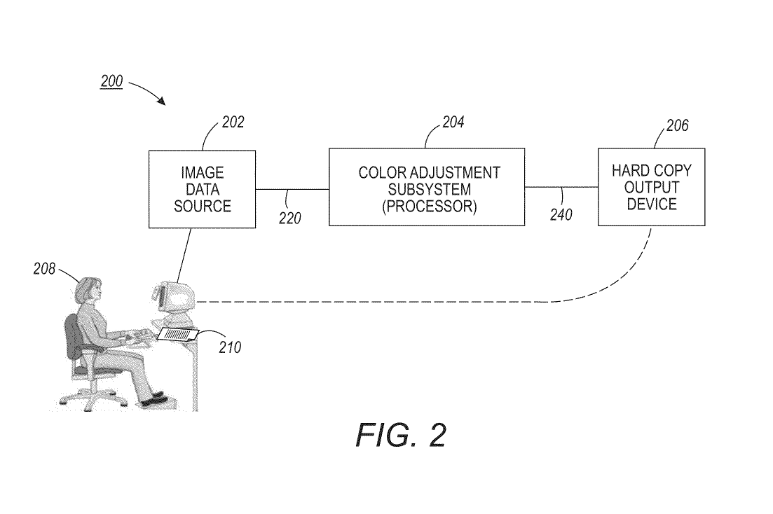

FIGS. 1A and 1B illustrate a method 100 for imaging of spot colors within a document using the spot color editing assistant tool in accordance with an embodiment of the present disclosure. Referring to FIGS. 1A and 1B, the method 100 is a computer-implemented method that is implemented in a computer system comprising one or more processors 204 (as shown in and explained with respect to FIG. 2) configured to execute one or more computer program modules.

Referring to FIGS. 1A and 1B, the method 100 begins at procedure 102. An image file (e.g., customer document) is loaded on an image printing system and released for printing at procedure 102. At procedure 104, the image file is reviewed to detect the presence of any spot colors. The spot color detection routine looks for any standardized document convention describing the use of spot colors and their names (e.g., names standardized by Pantone, Inc.) in the image file or document. Methods for detecting the presence of spot colors in different file formats are described, for example, in U.S. Pat. No. 6,456,395 to Ringness (“Method For Separating Colors Of Encapsulated Postscript Images”) and U.S. Pat. No. 7,738,140 to Hancock et al. (“System And Method For Automated Spot Color Editor”), which are herein incorporated by reference in their entirety. Optionally, the system of the present disclosure may allow the user to identify one or more user-added custom spot colors.

At procedure 106, a determination is made as to whether the image file contains spot colors. If no spot colors have been identified in the image file, at procedure 110, an image processing system raster image processes (RIPs) the image file and sends the image file to a marking device or a print engine 206 (as shown in and described with respect to FIG. 2).

If spot colors are present in the image file, at procedure 108, the processor 204 is configured to determine a spot color formula for providing a colorimetric match to a desired spot color in a print job.

The processor 204 (i.e., a printer model in the spot color editor) is used to search for the spot color recipes or formulas. Known search techniques are used when searching for the color model or spot color recipe having an accurate match to the desired spot color. The processor 204 is configured to identify the spot color formula without distorting other or neighborhood colors in the image file or document. The processor 204 is configured to find the spot color formula for target or desired values of the spot colors.

The desired spot color refers to spot color aims (CIELab values) or targets. These spot color Lab aims (CIELab values) or targets are provided by Pantone™ and other companies and are integrated into a Digital Front End (DFE) system. The target or desired values may be described in several forms for spot colors. For example, the target or desired values can be in any of the following color spaces: reflectance spectra, L*a*b*, CMYK, RGB, sRGB, parameters describing color, or even the color number.

In one embodiment, the processor 204 may be configured to determine target or desired values for user-added spot colors. That is, in case of user-added custom spot colors (i.e., not “Pantone 300” but a user-added custom spot color such as, for example, “MyRed”), Lab aims or targets do not exist in the system. CMYK values corresponding to the user-added custom spot color are available in the system. The Lab aims or targets for the user-added custom spot colors are calculated by sending the available CMYK values to the processor 204. Once the Lab aims or targets for the user-added custom spot colors are determined, these Lab aims or targets for the user-added custom spot colors are saved in the system and are used as the desired spot color (i.e., the spot color Lab aims or targets) for the user-added custom spot colors. In another embodiment, the system of the present disclosure allows the user to manually adjust or enter the target or desired values.

Methods for determining the spot color formula are described in U.S. Pat. No. 7,738,140 to Hancock et al. (“System And Method For Automated Spot Color Editor”), which is herein incorporated by reference in its entirety.

The spot color is within a color space. The color space may include at least one member selected from the group consisting of reflectance spectra, L*a*b*, XYZ, LHC, CMYK, RGB, sRGB, parameters describing color and a color number. The spot color formula includes colorant values for each color in the color space. For example, for CMYK color space, the spot color formula includes colorant values for Cyan (C) color, Magenta (M) color, Yellow (Y) color, and Black (K) color, respectively.

At procedure 112, a test image 210 (as shown in FIG. 2) of the spot color with the determined spot color formula is printed for analysis by the user 208 (as shown in FIG. 2). The processor 204 is configured to send the determined spot color formula to the print engine 206. The print engine 206 is configured to print the test image 210 of the spot color with the determined spot color formula.

At procedure 114, the user 208 visually inspects the color composition of the spot color test image to determine whether desired image quality is achieved. If the user 208 is satisfied with the image quality of the spot color test image, at procedure 110, the image processing system raster image processes (RIPs) the image file and sends the image file to the marking device or the print engine for printing.

If the user 208 is not satisfied with the image quality of the spot color test image, at procedure 116, the user 208 inputs a colorant value of at least one color within the color space.

As will be clear from the discussions below, when the user wants to get more or less of one colorant amount in the determined spot color recipe, the user inputs the amount they want for that colorant. The spot color editing assistant tool then uses the customized colorant amount (provided by the user) as a pre-condition and automatically calculates the other colorant amounts to match the spot color aims or targets.

At procedure 118, the processor 204 uses the received colorant value of the at least one color (i.e., from the user) to determine an updated spot color formula for providing a colorimetric match to the desired spot color in the print job. The updated spot color formula includes colorant values for all the other colors in the color space (i.e., along with the colorant value for the at least one color provided by the user). Thus, the updated spot color formula provides a colorimetric match to the desired spot color in the print job based on the received input.

The spot color editing assistant tool derives a full spot color recipe based on one colorant amount input by the user. The present disclosure allows the user to force one of the colorants (e.g., Cyan (C), Magenta (M), Yellow (Y), or Black (K)) in a color space (e.g., CMYK) to a fixed level, and the system uses this user input as a constraint when searching the color model or spot color recipe for an accurate match to the desired spot color. The spot color editing assistant tool thus helps the user to compose spot color recipes that satisfy their image quality preferences and also informs the reproduction accuracy to the user.

For example, a particular dark blue spot color may be built with a spot color recipe with high levels of C, M, and K (i.e., none at 100%). This spot color recipe may produce rough jaggy edges of small type in the image. The same dark blue spot color may also be obtained using an alternate spot color recipe having more C and less K. This alternate spot color recipe may produce smooth edges of small type and lines in the image. To identify this alternate spot color recipe, using the system of the present disclosure, the user first inputs a higher (e.g., 100%) C value and the system uses this higher value inputted by the user and returns the M and K values that still provide accurate match to the original target reference. In addition to accurate match, the alternate spot color recipe obtained by the system provides preferred image quality (e.g., smooth edges of small type and lines).

The system of the present disclosure uses a spot color recipe search engine to support the spot color editing assistant tool. This spot color recipe search engine is configured to search for the optimal spot color recipes in the colorant space. The printer model created during profiling is used to search the spot color recipes. This spot color recipe search engine uses the user pre-selected colorant value as optimization limitation condition or searching boundary. Various optimization methods may be used to search for the optimal spot color recipes, such as conjumap algorithm, Newton algorithm, direct search algorithm, etc.

In one embodiment, the received colorant value (i.e., from the user) is used as an optimization limitation condition or a searching boundary to determine the colorant values for all the other colors in the color space. In another embodiment, the received colorant value is constrained or fixed to determine the colorant values for all the other colors in the color space.

For four-colorant (e.g., CMYK) printing, only one colorant is pre-set by the user because there is only one redundant colorant in the four-colorant (e.g., CMYK) system. For other multiple-colorant (having more than four colorants) printing, such as six or seven-colorant printing, two or three colorants may be pre-set by the user based on the number of redundant colorants. For example, for CMYKOV printing, more than one colorant may be constrained.

If the pre-selected colorant amount limits the ability of the spot color editing assistant tool to find the colorant combination matching the target. The spot color editing assistant tool is configured to provide the closest result to the target and inform the user color difference between the closest result and the target.

At procedure 120, the processor 204 determines whether the updated spot color formula can be obtained based on the received input (i.e., at procedure 116) from the user.

If the processor 204 cannot determine the updated spot color formula using the received input (i.e., at procedure 116) from the user, at procedure 124, the processor 204 provides the user with a closest spot color formula for providing a closest colorimetric match to the desired spot color and also provides the user with a colorimetric difference between a spot color provided by the closest spot color formula and the desired spot color. Optionally, the system may allow the user to input another colorant value of at least one color within the color space to determine another (alternate) updated spot color formula that satisfies the user's image quality preferences

If the processor 204 determines the updated spot color formula using the received input (i.e., at procedure 116) from the user, at procedure 122, a second test image 210 of the spot color with the updated spot color formula is printed for analysis by the user 208. The processor 204 is configured to send the updated spot color formula to the print engine 206. The print engine 206 is configured to the test image 210 of the spot color with the updated spot color formula.

At procedure 126, the user 208 visually inspects the color composition of the second spot color test image to determine whether desired image quality is achieved. If the user 208 is satisfied with the image quality of the second spot color test image, at procedure 110, the image processing system raster image processes (RIPs) the image file and sends the image file to the marking device or the print engine for printing.

If the user 208 is not satisfied with the image quality of the second spot color test image, at procedure 116, the user 208 inputs another colorant value of at least one color within the color space. Next, procedures 116-126 are repeated to determine another (alternate) updated spot color formula that satisfy user's image quality preferences.

FIG. 2 illustrates a system 200 for imaging of spot colors within a document using a spot color editing assistant tool in accordance with an embodiment of the present disclosure. It is to be understood that certain aspects of the system 200 may operate in accordance with pre-programmed instructions used to operate a local or networked computer system to carry out such features-perhaps on a plurality of interconnected computers at a time. Such a system may include a commercially available personal computer with appropriate graphics rendering capability that can also be associated with a networked storage medium or similar memory device wherein the system is accessible, perhaps via an Internet or intranet for submission of print jobs. It is also contemplated that one or more aspects of the system may be implemented on a dedicated computer workstation.

As shown in FIG. 2, the print color adjustment system 200 is connected to an image data source 202, and includes color adjustment subsystem 204, and a hard copy output device 206. These devices are coupled together via data communication links 220 and 240. These links may be any type of link that permits the transmission of data, such as direct serial connections, a local area network (LAN), wide area network (WAN), an intranet, the Internet, circuit wirings, and the like.

The content for a printing job is initially provided by the user through the image data source 202 in a form acceptable to the system 200. The image data source 202 may be a personal computer, a microprocessor, a scanner, a disk drive, a tape drive, a hard disk, zip drive, CD-ROM drive, a DVD drive, a network server, a print server, a copying device, or any other known or later developed device or system that is able to provide the image data. The image data source 202 may include a plurality of components including displays, user interfaces, memory, disk drives, and the like.

The hard copy output device or print engine 206 may be any type of device that is capable of outputting a hard copy of an image and may take the form of a laser printer, a bubble jet printer, an ink jet printer, a copying machine, or any other known or later developed device or system that is able to generate an image on a recording medium using the image data or data generated from the image data. The hard copy output device 206 generates the hard copy of the image based on printable image data generated by the color adjustment subsystem 204. In one embodiment, the print engine 206 is configured to print a test image of the spot color with the spot color formula determined by the processor or the color adjustment subsystem 204

In one embodiment, the color adjustment subsystem or processor 204 is configured to determine a spot color formula for providing a colorimetric match to a desired spot color in a print job. The color adjustment subsystem or processor 204 is also configured to determine an updated spot color formula for providing a colorimetric match to the desired spot color in the print job based on a received input, if the desired image quality is not achieved.

Although for the purposes of description color adjustment system 200 is shown as a separate device from the image data source 202, the color adjustment system 200 may be an integrated device, such as a digital copier, a computer with a built-in printer, or any other integrated device that is capable of producing a hard copy image output. With such a configuration, for example, the image data source 202, the color adjustment subsystem 204, and the hard copy output device 206 may be contained within a single device. Furthermore, the color adjustment system 200 may be implemented as software on the color adjustment subsystem 204 or the image data source 202. Other configurations of the elements shown in FIG. 2 may be utilized without departing from the spirit and scope of the specification and claims herein.

The term “image”, as used in this present disclosure refers to a graphic or plurality of graphics, compilation of text, a contone or haftone pictorial image, or any combination or sub-combination thereof, that is capable of being output on a display device, a marker and the like, including a digital representation of such image. For example, an image may be a combination of graphics, text and pictures that is represented by a series of pixel values denoting the color, intensity, etc., of the particular pixels that make up the image. A special subclass of images is images associated with complete documents, which are referred to as “document images”. Thus an image may be a document image assembled by a user at the image data source 202, one or more elements of a document image, a “test patch” generated by printing application software or another type of control system, or a member of a collection of images in a database. The image data source 202 provides image data that, when used to display the image or convert the image into a hard copy, provides an approximate representation of the image. The image data source 202 provides the image data to the color adjustment system 200.

The image data input to the color adjustment subsystem 204 may be in either a device-dependent color space or a device-independent color space. For example, if the image data source 202 is a personal computer, the image data used for representing the image is typically in the RGB color space, since this is the color space used by a display of the image data source 202. These RGB values may be directly forwarded to the color adjustment subsystem 204 or may undergo conversion into a device-independent color space, such as L*a*b*, (the Commission Internationale de L′eclairage color standard) prior to being input to the color adjustment subsystem 204. L* defines lightness, a* corresponds to the red/green value, and b* denotes the amount of yellow/blue, which corresponds to the way the human eye perceives color. If the conversion of the device-dependent color space values into device-independent color space values is not performed by the image data source 202 when inputting the image data to the color adjustment system 200, then the color adjustment system 200 may perform the conversion between the color spaces.

The color adjustment subsystem 204 transforms the device-independent image data into printable image data based on the color space used by the hard copy output device 206. For example, if the hard copy output device 206 is a printer, the color space used by the printer will often be the CMYK color space. In such a case, the color adjustment subsystem 204 converts the device-independent image data into CMYK-color space printable image data for the appropriate target value. Alternatively, the target values may be described in any of the color spaces L*a*b*, CMYK, RGB or sRGB or even the color number, such as a Pantone® number.

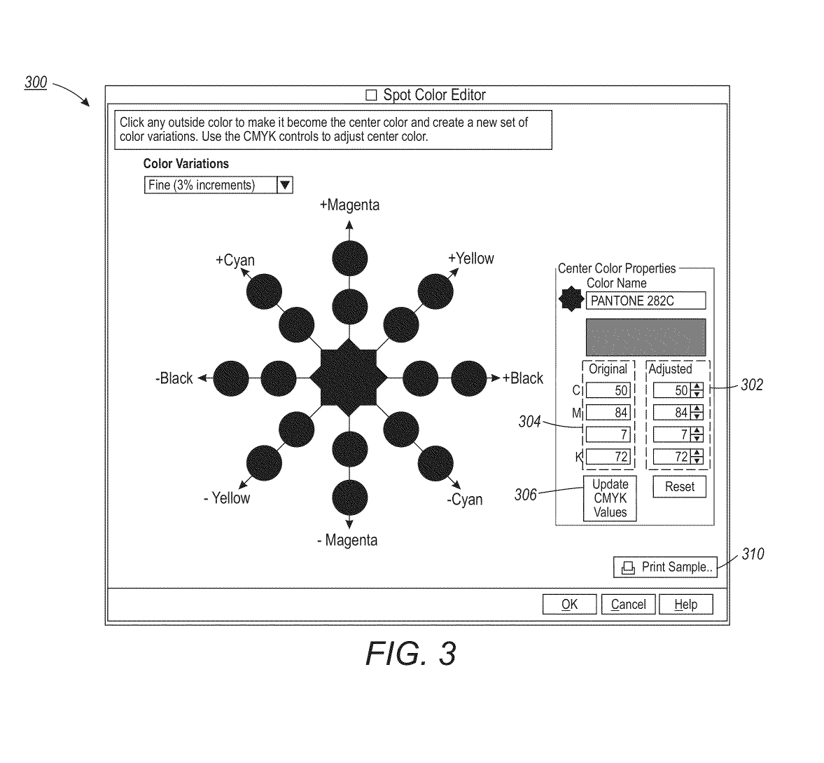

FIG. 3 is a graphical user interface (GUI) 300 depicting a spot color editing assistant tool in accordance with an embodiment of the present disclosure. In one embodiment, the user 208 edits their preferred CMYK value(s) on this interface 300, then visually compares the adjusted color 302 with original color 304 to check if they match each other or not. The user 208 may pre-set a value for one of the colorants either by manually entering a value or by adjusting the value (e.g., using the up and down arrows) for one of the colorants.

An additional control 306 (e.g., a button) is added to the existing spot color editor interface in order to integrate the spot color editing assistant tool with the existing spot color editor. This additional control 306 allows the user to activate the spot color editing assistant tool. After the user 208 pre-sets a value for one of the colorants, the user 208 then presses this additional control 306 to activate the spot color editing assistant tool. The spot color editing assistant tool then automatically generates values for all the other colorants and displays these values (for all the colors in the color model) under the adjusted color 302. The updated or new spot color formula or recipe renders same color as original CMYK combinations. The spot color editing assistant tool allows the user to visually compare the adjusted color 302 with original color 304 to determine if they match each other or not and to print a test image using the updated or new spot color formula or recipe to determine if desired image quality is achieved. The user may use a control 310 to print the test image.

Thus, the spot color editing assistant tool of the present disclosure enhances spot color editing capabilities. The spot color editing assistant tool of the present disclosure provides a complete spot color edit function for a Digital Front End (DFE), which includes the colorant editing and assistant tool to help user to choose among alternate recipes to achieve their preferred image quality. The spot color editing assistant tool of the present disclosure saves user's time and efforts to match spot color with a specific image quality goal. The spot color editing assistant tool of the present disclosure also provides possibilities for users to choose different recipes each achieving color accuracy. Thus, the spot color editing assistant tool of the present disclosure provides accurate spot color along with preferred image quality for customer or user satisfaction.

The spot color editing assistant tool of the present disclosure is a user-friendly editing tool for editing spot color recipes in spot color reproduction. The spot color editing assistant tool may be directly integrated into the existing automated spot color editor. The spot color editing assistant tool helps user to compose spot color recipes that satisfy their image quality preferences and also informs reproduction accuracy to the user. The spot color editing assistant editor can generate a spot color recipe based on user requirements and also let users know the most accurate spot color recipe they can get based on their requirements. The spot color editing assistant tool helps users to choose their preferred colorant combination for image quality with high accuracy for spot color reproduction. The spot color editing assistant tool improves user productivity when working with spot colors. Spot color workflows are critical in many printing applications, and productivity improvements in this area can be a positive product differentiator.

In describing the present disclosure, reference is made to various examples using cyan, magenta, yellow and black (CMYK) colorants to describe the method and system of the present disclosure. Generalization to other additional colorants (e.g., CMYKOV, CMYKOG, etc) is straightforward, however, and the use of particular examples using CMYK is not intended to limit the scope of the present disclosure.

In embodiments of the present disclosure, the processor, for example, may be made in hardware, firmware, software, or various combinations thereof. The present disclosure may also be implemented as instructions stored on a machine-readable medium, which may be read and executed using one or more processors. In one embodiment, the machine-readable medium may include various mechanisms for storing and/or transmitting information in a form that may be read by a machine (e.g., a computing device). For example, a machine-readable storage medium may include read only memory, random access memory, magnetic disk storage media, optical storage media, flash memory devices, and other media for storing information, and a machine-readable transmission media may include forms of propagated signals, including carrier waves, infrared signals, digital signals, and other media for transmitting information. While firmware, software, routines, or instructions may be described in the above disclosure in terms of specific exemplary aspects and embodiments performing certain actions, it will be apparent that such descriptions are merely for the sake of convenience and that such actions in fact result from computing devices, processing devices, processors, controllers, or other devices or machines executing the firmware, software, routines, or instructions.

While the present disclosure has been described in connection with what is presently considered to be the most practical and preferred embodiment, it is to be understood that it is capable of further modifications and is not to be limited to the disclosed embodiment, and this application is intended to cover any variations, uses, equivalent arrangements or adaptations of the present disclosure following, in general, the principles of the present disclosure and including such departures from the present disclosure as come within known or customary practice in the art to which the present disclosure pertains, and as may be applied to the essential features hereinbefore set forth and followed in the spirit and scope of the appended claims.

What is claimed is:

1. A computer-implemented method for imaging of spot colors within a document using a spot color editor, wherein the method is implemented in a computer system comprising one or more processors configured to execute one or more computer program modules, the method comprising:
determining a spot color formula, using a spot color editor, for providing a colorimetric match to a desired spot color in a print job, wherein the spot color is within a color space and the spot color formula comprises colorant values for each color in the color space;
printing a test image of the spot color with the determined spot color formula for analysis, wherein the color composition of the spot color test image is analyzed by a user to determine whether desired image quality is achieved; and
determining an updated spot color formula for providing a colorimetric match to the desired spot color in the print job based on a received input, if the desired image quality is not achieved.

2. The method of claim 1, wherein the determining the updated spot color formula comprises:
receiving, from the user, a colorant value of at least one color within the color space as the input; and
using the received colorant value of the at least one color to determine colorant values for all the other colors in the color space.

3. The method of claim 2, wherein the received colorant value is used as an optimization limitation condition or a searching boundary to determine the colorant values for all the other colors in the color space.

4. The method of claim 2, wherein the received colorant value is constrained or fixed to determine the colorant values for all the other colors in the color space.

5. The method of claim 1, further comprising printing a second test image with the updated spot color formula for analysis, wherein the color composition of the second spot color test image is analyzed by a user to determine whether desired image quality is achieved.

6. The method of claim 1, further comprising determining a closest spot color formula for providing a closest colorimetric match to the desired spot color, if the updated spot color formula cannot be determined based on the received input.

7. The method of claim 6, further comprising providing the user with a colorimetric difference between a spot color provided by the closest spot color formula and the desired spot color.

8. The method of claim 1, wherein the color space is at least one member selected from the group consisting of reflectance spectra, L*a*b*, XYZ, LHC, CMYK, RGB, sRGB, parameters describing color and a color number

9. A system for imaging of spot colors within a document using a spot color editor, the system comprising:
a processor configured to determine a spot color formula for providing a colorimetric match to a desired spot color in a print job, wherein the spot color is within a color space and the spot color formula comprises colorant values for each color in the color space; and
a print engine configured to print a test image of the spot color with the determined spot color formula for analysis, wherein the color composition of the spot color test image is analyzed by a user to determine whether desired image quality is achieved;
wherein the processor is configured to determine an updated spot color formula for providing a colorimetric match to the desired spot color in the print job based on a received input, if the desired image quality is not achieved.

10. The system of claim 9, wherein the processor is configured to:
receive, from the user, a colorant value of at least one color within the color space as the input; and
use the received colorant value of the at least one color to determine colorant values for all the other colors in the color space.

11. The system of claim 10, wherein the received colorant value is used as an optimization limitation condition or a searching boundary to determine the colorant values for all the other colors in the color space.

12. The system of claim 10, wherein the received colorant value is constrained or fixed to determine the colorant values for all the other colors in the color space.

13. The system of claim 9, wherein the print engine is configured to print a second test image of the spot color with the updated spot color formula for analysis, wherein the color composition of the second spot color test image is analyzed by a user to determine whether desired image quality is achieved.

14. The system of claim 1, wherein the processor is configured to determine a closest spot color formula for providing a closest colorimetric match to the desired spot color, if the updated spot color formula cannot be determined based on the received input.

15. The system of claim 14, wherein the processor is configured to provide the user with a colorimetric difference between a spot color provided by the closest spot color formula and the desired spot color.

16. The system of claim 1, wherein the color space is at least one member selected from the group consisting of reflectance spectra, L*a*b*, XYZ, LHC, CMYK, RGB, sRGB, parameters describing color and a color number
